(19) United States
(12) Patent Application Publication
(10) Pub. No.: US 2025/0174158 A1
(43) Pub. Date: May 29, 2025

(54) Chain of Custody Security Seal System

(71) Applicant: J.J. Keller & Associates, Inc., Neenah, WI (US)

(72) Inventors: Jason Jon Kreidler, Sheboygan, WI (US); Kevin Roger Kucksdorf, Hortonville, WI (US); Benjamin Luke Burleson, College Station, TX (US); Cory Brent Christofferson, Cloquet, MN (US); Joel Clark, Sherwood, WI (US); Paul E. Paulick, Oshkosh, WI (US)

(21) Appl. No.: 19/039,420

(22) Filed: Jan. 28, 2025

Related U.S. Application Data
(62) Division of application No. 18/221,048, filed on Jul. 12, 2023.

(51) Int. Cl. G09F 3/00; G09F 3/02

(52) U.S. Cl. CPC G09F 3/0292; G09F 2003/0208

(57) ABSTRACT

A security seal system including a first security seal and a second security seal. The first security seal is inoperable after having been removed from an object. The first security seal has a custody aperture. The second security seal is secured to the same object. The second security seal passes through the custody aperture of the first security seal so that the first security seal is secured to the second security seal.

### CROSS REFERENCE TO RELATED APPLICATION

This application is a divisional of U.S. patent application Ser. No. 18/221,048, filed on Jul. 12, 2023, the entirety of which is hereby incorporated by reference.

### FIELD OF THE INVENTION

The invention relates to a security seal system and, preferably, to a security seal system for maintaining the chain of custody of at least one inoperable security seal.

### BACKGROUND OF THE INVENTION

Security seals are used extensively within the trucking industry. The purpose of a security seal is generally to provide tamper evidence by breaking in a designed way when the cargo is accessed by anyone. Each security seal has a unique identifier and cannot be resealed once broken to provide immediate visual evidence that the cargo has been accessed or tampered with.

When transporting cargo that is sealed with a security seal, there are times when the security seal must be broken for someone, such as for example a DOT officer, to inspect the cargo. The driver must maintain a record of this and retain the removed or broken security seal. This is often done by attaching the broken security seal to paperwork. However, broken security seals often get lost or misplaced when kept with the paperwork such as in the cab of a truck.

### SUMMARY OF THE INVENTION

In one construction, the disclosure provides a security seal system including a first security seal that is inoperable after having been removed from an object, the first security seal having a custody aperture and a second security seal secured to the same object, the second security seal passing through the custody aperture of the first security seal so that the first security seal is secured to the second security seal.

In another construction, the disclosure provides a security seal system including a first security seal having a unique identifier and a custody aperture and a second security seal having thereon the same unique identifier, wherein the second security seal passes through the custody aperture of the first security seal so as to secure the first security seal to the second security seal.

In another construction, the disclosure provides a security seal system including a first security seal having a custody aperture and a second security seal passing through the custody aperture of the first security seal such that the second security seal maintains custody of the first security seal.

In another construction, the disclosure provides a security seal system including a first security seal having a custody aperture, a second security seal having a custody aperture and a third security seal passing through the custody aperture of the first security seal and the custody aperture of the second security seal such that the third security seal maintains custody of the first and the second security seals.

Other aspects of the disclosure will become apparent by consideration of the detailed description and accompanying drawings.

### BRIEF DESCRIPTION OF THE DRAWINGS

FIG. 1 is a perspective view of a security seal of the present invention.

FIG. 2 is a perspective view of a removed first security seal and a second security seal.

FIG. 3 is a perspective view of a removed first and second security seal and a third security seal.

FIG. 4 is a perspective view of a removed truncated first and second security seal and a third security seal.

FIG. 5 is a top view of another embodiment of a security seal.

FIG. 6 is a top view of another embodiment of a security seal.

FIG. 7 is a top view of another embodiment of a security seal.

### DETAILED DESCRIPTION OF THE INVENTION

Before any constructions of the disclosure are explained in detail, it is to be understood that the disclosure is not limited in its application to the details of construction and the arrangement of components set forth in the following description or illustrated in the following drawings. The disclosure is capable of other constructions and of being practiced or of being carried out in various ways.

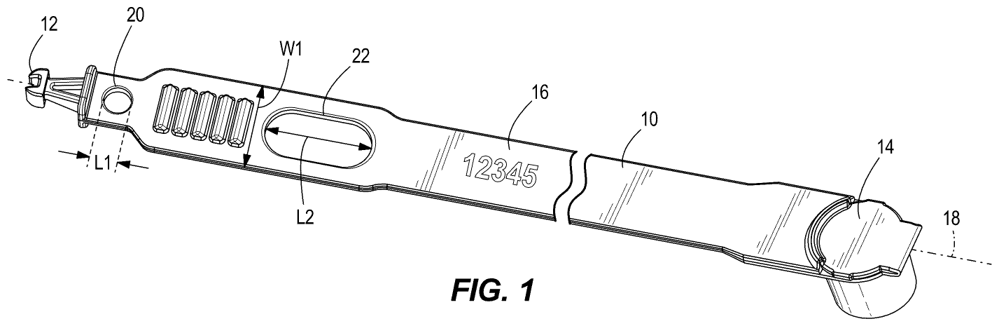

FIG. 1 illustrates a plastic security seal 10. The security seal 10 is preferably molded from plastic such as high density polyethylene, however, other materials can also be utilized. It should be noted that the invention can be applied to other types of security seals such as, for example, pull tight seals, metal seals, cable seals and the like.

The security seal 10 includes a tip 12, a receptacle 14, and a middle portion or band 16 therebetween defining a longitudinal axis 18. The tip 12 is designed to enter the receptacle 14 in one direction and be held in the receptacle 14 so that the security seal 10 forms a loop through an object to be secured, as is known in the art. The middle band 16 has a width of W1. The middle band 16 may have a plurality of differing widths with W1 being the largest. A unique identifier, such as 12345 as shown in FIG. 1, is applied to the band 16 as is known in the art. The unique identifier can be any combination of letters, numbers, and symbols as is known in the art.

The security seal 10 can include a breakpoint cutout 20 where the security seal 10 is designed to break as a tamper proof feature when pulled upon or break when being removed. When under tension in the process of breaking or removing the security seal 10 from an object, the breakpoint cutout 20 is the weakest part of the security seal 10 and breaks first. The breakpoint cutout 20 is preferably adjacent to the tip 12 and is shown as circular, however, other positions and shapes can also be utilized. The breakpoint cutout 20 has a length L1 with respect to the longitudinal axis 18.

The security seal 10 includes a custody aperture 22. The custody aperture 22 is shown further from the tip 12 than the breakpoint cutoff 20 and oblong, however, other positions and shapes can also be utilized such as circular and rectangular. The custody aperture 22 has a length L2 along the longitudinal axis 18. The length L2 of the custody aperture is larger than length L1 of the breakpoint cutout 20.

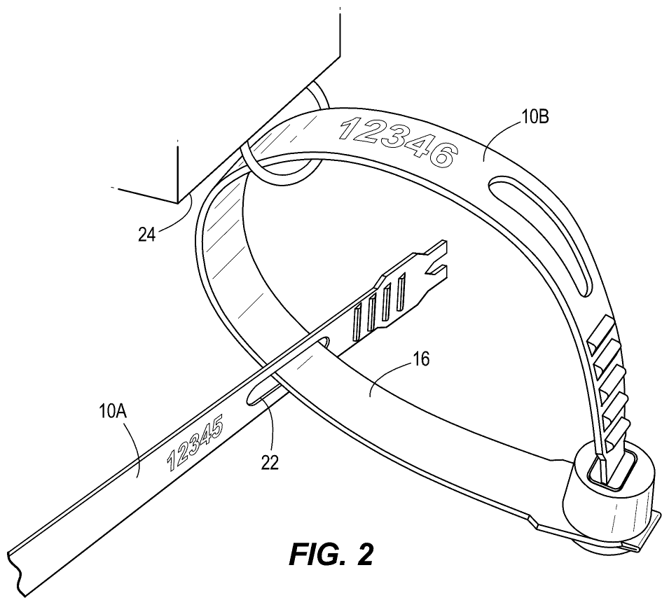

As shown in FIG. 2, there is a broken security seal 10A and a second security seal 10B in its secured and looped position security an object 24. The custody aperture 22 of the broken security seal 10A is designed to house and the second security seal 10B such that both seals 10A and 10B are secured together. The length L2 of the custody aperture 22 is larger than the width W1 of the middle band such that the security seal 10B can be threaded through the custody aperture 22 of the broken seal 10A.

In operation, the custody aperture 22 aids in the chain of custody process. During the shipping process or at other like times, a security seal 10A may need to be broken and removed such as by a DOT officer inspecting the cargo, and a second security seal 10B needs to be affixed. The user feeds the second security seal 10B through the custody aperture 22 of the broken security seal 10A and then secures the second security seal 10B to the object 24 thus making a loop and having the broken security seal 10A attached thereto. In this orientation, the broken security seal 10A is retained for record-keeping purposes and provides visual verification that the broken security seal 10A has been legitimately broken and a second security seal 10B affixed. Use of the custody aperture 22 provides a more secure and reliable method to track security seals that have been broken in transit by attaching them to a second security seal 10B that replaces the broken security seal 10A.

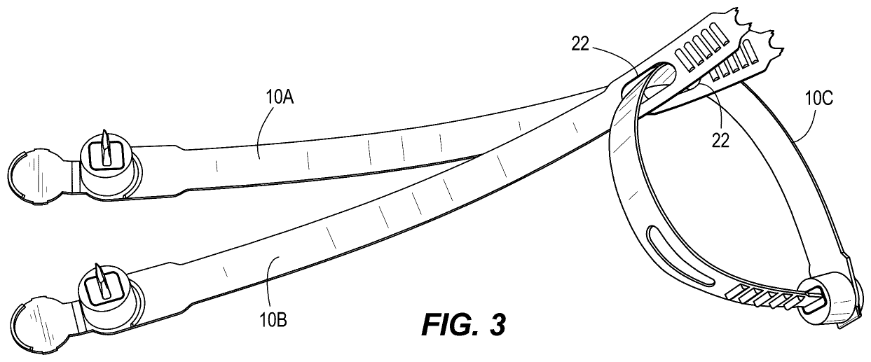

Turning to FIG. 3, more than one broken security seal 10 can be connected. Two broken security seals 10A and 10B are connected to a third security seal 10C that is in use. The third security seal 10C is threaded through the custody apertures 22 of each of the first security seal 10A and the second security seal 10B. Further, for example and not shown, three broken security seals can be connected to a fourth security seal that is in use. The fourth security seal is threaded through the custody aperture of each of the first, second and third security seals and so on for any number of security seals.

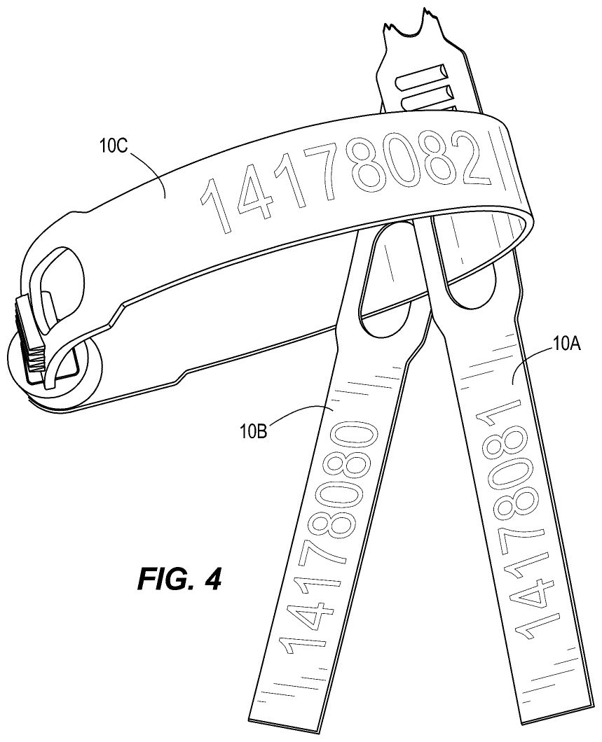

With reference to FIG. 4, there is shown a portion of a broken security seal 10A secured to a security seal 10C. After the security seal 10A is broken and removed from the object 24, it is truncated or shortened so that only the portion of the security seal having thereon the unique identifier remains. The security seals 10A can be truncated such as by cutting or having a truncation portion that enables severing of the security seal into at least two portions. FIG. 4 shows a second truncated security seal 10B secured to the security seal 10C, however, it should be noted that security seal 10B could also be non-truncated and secured in its full length if desired.

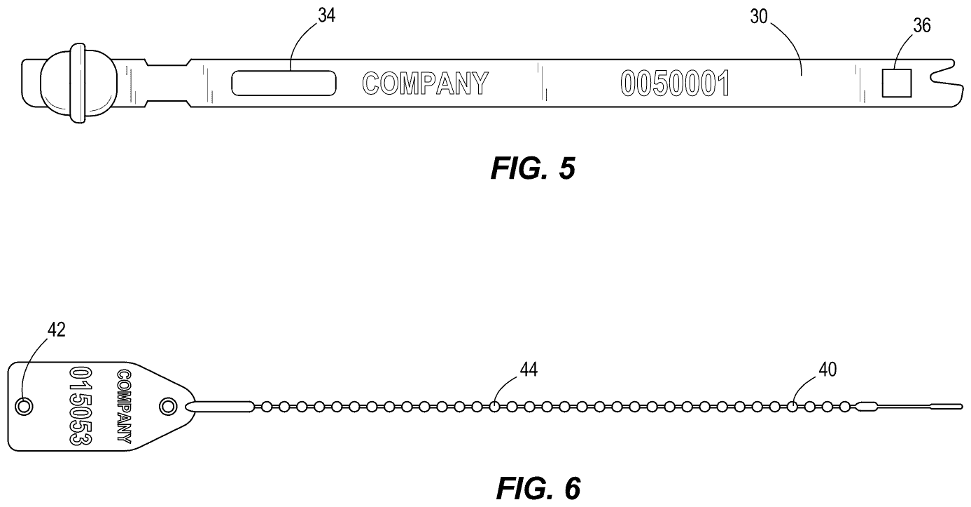

With reference to FIG. 5, there is shown a metal security seal 30 have a custody aperture 34 adapted to house a broken metal security seal to maintain its custody. The seal 30 has an intended break point 36 when the seal 30 is removed from an object. Alternatively, users can cut the seal 30 to remove it from the object.

With reference to FIG. 6, there is shown a plastic pull tight security seal 40 having a custody aperture 42 adapted to house a broken plastic pull tight security seal and maintain its custody. A tail 44 is the designed weakest portion or break point when the seal 40 is removed from an object.

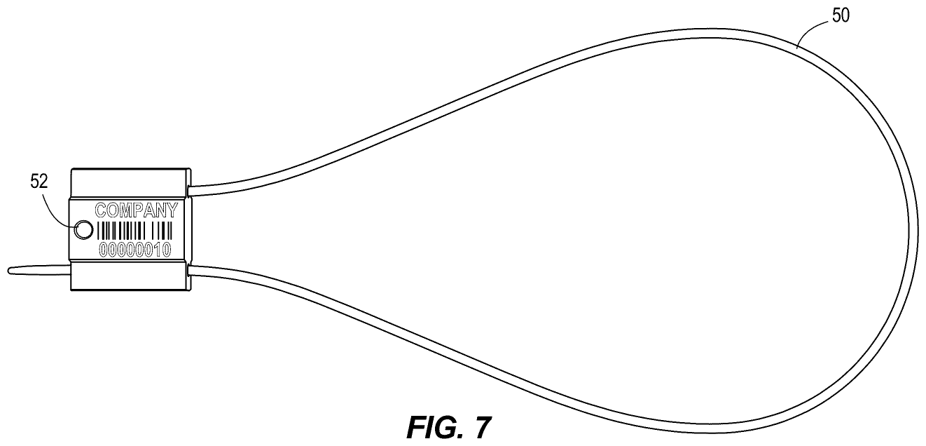

With reference to FIG. 7, there is shown a metal cable security seal 50 having a custody aperture 52 adapted to house a broken metal cable security seal and maintain its custody. The seal 50 does not have a break point. A cable cutter or like device is used to remove the seal 50 from an object.

Various features and advantages of the invention are set forth in the following claims.

What is claimed is:

1. A security seal system comprising:
a first security seal that is inoperable after having been removed from an object, the first security seal having a custody aperture; and
a second security seal secured to the same object, the second security seal passing through the custody aperture of the first security seal so that the first security seal is secured to the second security seal.

2. The security seal system of claim 1 wherein the custody aperture has a shape that is one of oblong, circular or rectangular.

3. The security seal system of claim 1 wherein the first and second security seals are one of a plastic security seal, a metal security seal, a cable security seal and a pull tight security seal.

4. The security seal system of claim 1 and wherein the second security seal further includes a breakaway cutout adapted to break before the custody aperture when the second security seal is under tension.

5. The security seal system of claim 1 wherein the first security seal and the second security seal are identical.

6. A security seal system comprising:
a first security seal having a unique identifier and a custody aperture; and
a second security seal having thereon the same unique identifier, wherein the second security seal passes through the custody aperture of the first security seal so as to secure the first security seal to the second security seal.

7. The security seal system of claim 6 wherein the second security seal includes a custody aperture.

8. The security seal system of claim 6 and further includes raised ridges adjacent to the custody aperture.

9. The security seal system of claim 6 wherein the custody aperture has a shape that is one of oblong, circular or rectangular.

10. The security seal system of claim 6 wherein the first and second security seals are one of a plastic security seal, a metal security seal, a cable security seal and a pull tight security seal.

11. The security seal system of claim 6 wherein the first security seal and the second security seal are identical.

12. A security seal system comprising:
a first security seal having a custody aperture; and
a second security seal passing through the custody aperture of the first security seal such that the second security seal maintains custody of the first security seal.

13. The security seal system of claim 12 wherein the second security seal has a custody aperture.

14. The security seal system of claim 12 wherein the first and second security seals are one of a plastic security seal, a metal security seal, a cable security seal and a pull tight security seal.

15. The security seal system of claim 12 wherein the first security seal and the second security seal are identical.

16. The security seal system of claim 12 wherein the first security seal is inoperable.

17. The security seal system of claim 12 wherein the first security seal has been removed from an object and wherein the second security seal is secured to the same object.

18. The security seal system of claim 12 wherein each of the first and the second security seals has a unique identifier thereon.

19. The security seal system of claim 18 wherein the unique identifier on the first and second security seals is the same unique identifier.

20. A security seal system comprising:
a first security seal having a custody aperture;
a second security seal having a custody aperture; and
a third security seal passing through the custody aperture of the first security seal and the custody aperture of the second security seal such that the third security seal maintains custody of the first and the second security seals.
